(19) United States
(12) Patent Application Publication
(10) Pub. No.: US 2003/0071557 A1
(43) Pub. Date: Apr. 17, 2003

(54) Color cathode ray tube

(76) Inventors: Yoshiyuki Odaka, Isumi (JP); Yuko Matsumoto, Onjuku (JP); Yoshio Yoshiwara, Mobara (JP); Satoshi Muto, Mobara (JP); Yasumasa Tsuchiya, Mobara (JP); Jun Mochizuki, Fujisawa (JP)

Correspondence Address: Milbank, Tweed, Hadley & McCloy LLP, 1 Chase Manhattan Plaza, New York, NY, 10005-1413, US

(21) Appl. No.: 10/163,646

(22) Filed: Jun. 6, 2002

(30) Foreign Application Priority Data
Jun. 20, 2001 (JP) 2001-186656

(51) Int. Cl. H01J 29/80

(52) U.S. Cl. 313/408

(57) ABSTRACT

The present invention provides an excellent color cathode ray tube of a black matrix type which can reduce the irregularities of a phosphor screen, can exhibits the uniformity of screen, can exhibit the favorable quality of screen, and can obtain the image display of high quality. The size T of a boundary portion between a large hole and a small hole of each electron beam aperture formed in a shadow mask is made small and the surface roughness of an inner surface is made small so that the Irregularity index which expresses the uniformity of the phosphor screen can be set to a value not greater than 7%.

### BACKGROUND OF THE INVENTION

1. Field of the Invention

The present invention relates to a color cathode ray tube, and more particularly to a color cathode ray tube of a black matrix type having phosphor pixels and a black matrix film which surrounds the phosphor pixels and is formed of a non-luminescence light-absorbing material layer on an inner surface of a panel.

2. Description of the Related Art

As a video tube of a television receiver set or a monitor tube of a personal computer or the like, a color cathode ray tube of a black matrix type has been popularly adopted. FIG. 4 is a schematic cross-sectional view for explaining an example of the structure of the color cathode ray tube of a black matrix type. The color cathode ray tube includes an evacuated envelope which consists of a panel portion 20, a funnel portion 21 and a neck portion 22. An anode button 23 for introducing high voltage is embedded in a portion of the funnel portion 21.

Numeral 24 indicates a shadow mask assembled body and the detail of one example of the shadow mask assembled body 24 is shown in FIG. 5A and FIG. 5B and will be explained later. Numeral 25 indicates an electron gun which is housed in the inside of the neck portion 22. High voltage introduced through the anode button 23 is applied to the electron gun 25 through an inner conductive film. Numeral 26 indicates a deflection yoke and is exteriorly mounted on a transitional region between the neck portion 22 and the funnel portion 21 of the evacuated envelope. By deflecting three modulated electron beams 27 irradiated from the electron gun 25 in the horizontal direction (X direction) and in the vertical direction (Y direction) using the deflection yoke 26, the electron beams 27 are subjected to a two-dimensional scanning on a phosphor screen 28 thus reproducing images. The high voltage introduced through the anode button 10 is also applied to a conductive film which is formed on the phosphor screen 28. In the drawing, numeral 29 indicates a magnetic shield.

The phosphor screen 28 formed on an inner surface of the panel portion 20, one example of the phosphor screen 28 being shown in detail in FIG. 6 as will be explained later, includes tri-color phosphor pixels which are formed of phosphors of three colors generally consisting of red (R), green (G), blue (B) and which are applied in a dot shape or in a stripe shape and a black matrix film which surrounds the phosphor pixels. A color selection electrode assembled body is arranged close to the phosphor screen 28 and also faces the phosphor screen 28 in an opposed manner. Here, the color selection electrode assembled body is also referred to as the shadow mask assembled body 24 and a color selection electrode is explained as the shadow mask.

FIG. 5A and FIG. 5B show one example of the shadow mask assembled body 24 shown in FIG. 4. That is, FIG. 5A and FIG. 5B show the shadow mask assembled body 24 to which a shadow mask, a mask frame and springs are fixedly mounted, wherein FIG. 5A is a side view and FIG. 5B is a plan view. Portions identical with the portions which appear in the previously mentioned respective drawings are given same numerals. In FIG. 5A and FIG. 5B, the shadow mask assembled body 24 is constituted of a shadow mask 241, a mask frame 242 and springs 243. The shadow mask 241 includes a main surface 241a which has a large number of electron beam passage apertures 244 a shape of which is shown in FIG. 7 and which will be explained later as an example and skirt portions which are bent from the main surface 241a at an approximately right angle. The skirt portions are inserted into the inside of the mask frame 242 and the skirt portions and the mask frame 242 are fixed to each other by welding at portions indicated by a mark x.

Further, the springs 243 are fixedly secured by welding to respective sides of the mask frame 242 and constitute portions of a mechanism which suspends the shadow mask assembled body 24 in the inside of the panel portion 20. Still further, after shaping, the main surface 241a of the shadow mask constitutes a portion which faces the phosphor screen constituting an inner surface of the panel portion and is constituted of an apertured region where the large number of electron beam passage apertures 244 are formed and an outer peripheral portion constituting an outside non-apertured region which surrounds the periphery of the apertured region and is indicated by a dotted line. The main surface 241a has an approximately rectangular shape and respective radii of curvatures along a long axis, a short axis and a diagonal line are made different from each other. Such a provision is made to satisfy both of demands for a color cathode ray tube, that is, the flat feeling of the screen and the maintenance of the mechanical strength of the shaped shadow mask.

The shadow mask 241 mainly uses aluminum-killed steel as the constitutional material. Here, along with the recent demand for high definition to the color cathode ray tube, a shadow mask having a thin film thickness has been used. The color cathode ray tube which adopts such a thin shadow mask is liable to be subjected to a phenomenon which is referred to as mask doming in which a portion of the shadow mask is thermally deformed during the operation of the color cathode ray tube so that electron beam spots are deviated from given positions on the phosphor screen.

To cope with such a phenomenon, the mechanism which suspends the shadow mask assembled body in the inside of the panel portion is improved and further Invar material is used as the constitutional material of the shadow mask in view of the thermal expansion coefficient and the physical hardness. Such a shadow mask is formed into a mask assembled body in such a manner that an original plate in which a large number of electron beam passage apertures are formed at given positions by etching is blanked in a given shape and, thereafter, is formed by press forming into a shape consisting of a main surface having an approximately rectangular shape and formed in an approximately spherical shape and skirt portions which are contiguously connected to a periphery of the main surface and are bent by approximately 90 degrees with respect to the main surface, and the shaped shadow mask is fixedly secured to the mask frame.

FIG. 6 is a schematic cross-sectional view showing a portion of an essential part of the color cathode ray tube shown in FIG. 4 in an enlarged form. In FIG. 6, the phosphor screen 28 provided to the inner surface of the panel portion 20 includes tri-color phosphor pixel elements 281 which are formed of phosphors of three colors applied in a dot shape or in a stripe shape, a black matrix film 282 which surrounds the phosphor pixel elements 281 and a metal reflection film 283. Further, as previously explained, the shadow mask assembled body 24 is arranged close to the phosphor screen 28 in an opposed manner.

The tri-color phosphor pixels 281 are formed in a dot shape and are constituted of red (R) phosphor pixels 281R, green (G) phosphor pixels 281G and blue (B) phosphor pixels 281B. The tri-color phosphor pixels 281 are formed through steps in which, as well known, phosphor slurries of respective colors are applied to an inner surface of the panel portion on which the black matrix film 282 is formed and, thereafter, exposure indicated by an arrow is performed from positions of three light sources 30G, 30B, 30R indicated by a phantom line individually through the electron beam passage apertures 244 formed in the shadow mask 241.

FIG. 7 is a schematic cross-sectional view showing an example of the electron beam aperture 244 formed in the shadow mask 241. In FIG. 7, the electron beam aperture 244 exhibits a shape which is formed by combining two holes which differ in size with respect to a boundary portion, wherein the large hole (first hole portion) 244L faces the phosphor screen 28 side with respect to the boundary portion 244B and the small hole (second hole portion) 244S faces the electron gun 25 side with respect to the boundary portion 244B. The large hole (first hole portion) 244L and the small hole (second hole portion) 244S change their curving directions at an inflection point P0. That is, the electron beam aperture 244 formed in the shadow mask shown in FIG. 7 is constituted of two hole portions, that is, the large hole (first hole portion) 244L and the small hole (second hole portion) 244S. As mentioned previously, the electron beam passage apertures 244 are generally formed by etching the thin metal plate and it is more difficult to form holes in Invar material than to form holes in aluminum killed steel.

FIG. 8 is a geometric optical exposure profile for explaining the phosphor screen forming exposure. In the drawing, parts identical with those shown in the previously-mentioned respective drawings are given with same numerals. In FIG. 8, an exposure amount profile 31 is used in a following method. That is, the exposure amount profile 31 exhibits a maximum area Dmax at the panel portion 20, wherein corresponding to the increase of distance in the direction away from the panel portion, the exposure intensity is increased and the area is decreased and assumes the minimum area Dmin at a top surface. By setting the specification to a given position 311, for example, the phosphor pixels having the necessary area D is formed. The phosphor screen of such a color cathode ray tube of a black matrix type is disclosed in Japanese Patent Publication 218/1971 and the like, for example.

In the conventional color cathode ray tube of a black matrix type in which the black matrix film surrounds the phosphor pixels having the above-mentioned constitution, there have been problems that the coarse irregularities of contrast is generated on the phosphor screen so that the uniformity of the screen is degraded and the quality of the screen is damaged so that the image display of high quality cannot be obtained. Particularly, with respect to the monitor tube, beside the demand for high definition of the screen, a viewer usually reads images at a position very close to the screen, that is, approximately 50 cm from the screen, for example, and hence, there arises a problem that the fluctuation of brightness derived from the irregularities is liable to give fatigue to viewer's eyes.

To explain this problem using drawings, FIG. 9A and FIG. 9B are front views of the panel portion 20, wherein FIG. 9A is an overall view and FIG. 9B is a plan view showing a portion A in FIG. 9A in an enlarged manner. In these drawings, parts which are indicated by same symbols used in the previously-mentioned respective drawings correspond to identical parts. In FIG. 9B, among the phosphor pixels 281 which constitute the phosphor screen 28, a plurality of phosphor pixels 281B1, 281B2, 281B3, 281R3, 281G4 exhibit non-circular shapes and the red phosphor pixels 281R are pixels of a small diameter.

These irregular phosphor pixels are formed due to the exposure profiles shown in FIG. 10B and FIG. 10C. That is, while FIG. 10A shows the exposure profile of the regular phosphor pixel, FIG. 10B shows the exposure profile which is defective at points c1, d1 and hence, as the phosphor pixels on the phosphor screen, the phosphor pixels which have irregular shapes such as the blue phosphor pixels 281B2, 281B3 and the red phosphor pixels 281R3 which are partially defective are formed.

Further, the exposure profile shown in FIG. 10C exhibits a hang-out portion as indicated by points c2, d2 and hence, as the phosphor pixels on the phosphor screen, the phosphor pixels such as the blue phosphor pixel 281B1 and the green phosphor pixel 281G4 having irregular shapes which have portions thereof projected are formed. Since these irregular phosphor pixels are interspersed among the regular phosphor pixels, there arises a problem that the coarse irregularities of contrast are generated on the screen so that the uniformity of the screen is damaged and the quality of images is damaged whereby the image display of high quality cannot be obtained.

Such irregularities of the phosphor screen is generated by respective causes which are respectively present with respect to the shadow mask, the panel, the black matrix film, the phosphor pixels and metal reflective films and the like which are related with the formation of the phosphor screen. These causes are explained by taking the shadow mask as an example. FIG. 11 is a schematic cross-sectional view of another example of the electron beam aperture formed in the shadow mask. In FIG. 11, a large number of electron beam passage apertures 244 formed in the shadow mask 241 are formed such that each electron beam aperture 244 is constituted of a large hole (first hole portion) 244L formed in the panel side, a small hole (second hole portion) 244S formed at the electron gun side and a boundary portion (third hole portion) 244B which connects the large hole (first hole portion) 244L and the small hole (second hole portion) 244S.

A boundary between the first hole portion 244L and the third hole portion 244B is defined as a first inflection point P1 which reaches the third hole portion 244B from the first hole portion 244L and a boundary between the second hole portion 244S and the third hole portion 244B is defined as a second inflection point P2 which reaches the third hole portion 244B from the second hole portion 244. That is, in other words, the electron beam aperture 244 formed in the shadow mask shown in FIG. 11 is constituted of three portions, that is, the first hole portion, the second hole portion and the third hole portion.

With respect to the shadow mask having these electron beam passage apertures, the third hole portion 244B which constitutes the boundary portion of the electron beam passage apertures 244 formed in the shadow mask 241 shown in FIG. 11 has a broad width T in the thickness direction compared to the boundary portion 244B of the electron beam aperture 244 explained in conjunction with FIG. 7 so that the irregularities of the phosphor screen is generated due to the irregular reflection of the exposure beams on the boundary portion. Further, the irregularities of the phosphor screen is also generated due to the surface roughness of the inner surface of the electron beam passage apertures 244. Further, the thickness of the black matrix film, problems on the particle size of the phosphor per se, the composition of filming, the thickness of the metal reflection film and the like also affect the irregularities of the phosphor screen. The previously mentioned irregularities of the phosphor screen are generated as the result of the combination of these respective causes so that there arises a problem that the image display of high quality can not be obtained. In view of such a circumstance, a measure which can solve such a problem is requested. The evaluation of the irregularities of the phosphor screen largely depends on individuals who judge the irregularities of the phosphor screen with their naked eyes so that there has been a problem that the accurate judgement can not be attained. A technique which can quantitatively measure the irregularities of phosphor screen is disclosed in Japanese Laid-open Publication 253497/1998.

That is, FIG. 12 is a view showing the constitution of one embodiment of an image measuring method and device disclosed in the above-mentioned publication. In FIG. 12, numeral 32 indicates a color cathode ray tube which is subjected to an inspection, numeral 33 indicates a camera, numeral 34 indicates an image processor, and numeral 35 indicates a signal generator. Using these devices, one or plurality of physical characteristic quantities which respective pixels have such as an area of the phosphor dot, an amount of light emission from the phosphor dot per unit area, the irregularities of light emission distribution in the inside of the phosphor dot and shapes of the phosphor dots which are subjected to an inspection are extracted, the quantitative criterion are calculated, and the quality of images is evaluated.

According to this publication, the Irregularity index which expresses the uniformity of the phosphor screen can be obtained by a method in which out of the above-mentioned various physical characteristic quantities, one physical characteristic such as the area of the phosphor dot or a plurality of physical characteristic quantities such as the area of the phosphor dot and the light emission quantity of the phosphor dot per unit area are extracted, a numerical value which is obtained by subtracting the minimum value of the extracted characteristic quantity from the maximum value of the extracted characteristic quantity is divided by the average value of the characteristic quantity, and the obtained value is expressed by percentage so as to quantify the value.

That is, to explain the above processing by an equation, the equation is expressed as follows.

Irregularity index (%)=[{(maximum value of characteristic quantity)−(minimum value of characteristic quantity)}/(average value of characteristic quantity)]×100

Although the quantification of the irregularities becomes possible, problems derived from the generation of the irregularities have not been solved. Accordingly, it is an object of the present invention to provide an excellent color cathode ray tube of a black matrix type which can suppress the generation of the irregularities, can exhibit the excellent uniformity of the screen, can exhibit the excellent quality of screen and can obtain the image display of high quality.

### SUMMARY OF THE INVENTION

To achieve the above-mentioned object, the present invention has reduced causes or factors which generate irregularities at respective steps relevant to the formation of a phosphor screen so as to enhance the uniformity of the screen. To describe typical constitutions of the present invention, they are as follows.

(1) In a color cathode ray tube having an evacuated envelope which is constituted of a panel portion which includes a phosphor screen having phosphor pixels and a black matrix film on an inner surface thereof and a shadow mask being arranged to face the phosphor screen in an opposed manner and having a large number of electron beam passage apertures, a neck portion housing an electron gun and a funnel portion connecting the panel portion and the neck portion to each other and mounting a deflection yoke on an outer periphery thereof, the Irregularity index which expresses the uniformity of the phosphor screen is not greater than 7%.

(2) In the above-mentioned constitution (1), the Irregularity index is not greater than 5.5%.

(3) In the above-mentioned constitution (1) or (2), the phosphor pixels are formed in a dot shape.

(4) In any one of the above-mentioned constitutions (1) to (3), each electron beam aperture is formed in the shadow mask such that a large hole is formed at the phosphor screen side and a small hole is formed at the electron gun side with respect to a boundary portion, and the thickness of the boundary portion is set to a value not greater than 5 μm.

(5) In any one of above-mentioned constitutions (1) to (4), with respect to the shadow mask, the surface roughness of the inner surface of the electron beam aperture is set to a value not greater than 0.4 μm.

(6) In any one of above-mentioned constitutions (1) to (5), the Irregularity index which expresses the uniformity of the black matrix film is set to a value not greater than 5%.

(7) In any one of above-mentioned constitutions (1) to (6), the Irregularity index which expresses the uniformity of the shadow mask is set to a value not greater than 3%.

(8) A color cathode ray tube includes an evacuated envelope which is constituted of a panel having a phosphor screen which forms a large number of sets of three-color phosphor pixel trios on an inner surface thereof, a neck housing an electron gun which irradiates three electron beams toward the phosphor screen in the inside thereof and a funnel which connects the panel and the neck to each other, and a shadow mask which arranges an apertured region thereof which performs color selection of landing positions of the three electron beams and in which a large number of electron beam passage apertures are formed close to the phosphor screen and makes the apertured region face the phosphor screen in an opposed manner, wherein each electron beam aperture formed in the shadow mask is constituted of a first hole portion opened at the panel side, a second hole portion opened at the electron gun side and a third hole portion which connects the first hole portion and the second hole portion to each other, and with respect to a cross-sectional profile shape of the electron beam aperture which is obtained by cutting along a plane which includes the center of the electron beam aperture and a tube axis, a boundary between the first hole portion and the third hole portion is defined as a first inflection point which reaches the third hole portion from the first hole portion and a boundary between the second hole portion and the third hole portion is defined as a second inflection point which reaches the third hole portion from the second hole portion, and the distance between the first inflection point and the second inflection point is set to a value not greater than 5 μm.

(9) In the above-mentioned constitution (8), material which constitutes the shadow mask is Invar.

(10) In the above-mentioned constitution (8), the surface roughness in the vicinity of the third hole portion is set to a value not greater than 0.4 μm.

The present invention is not limited to the above-mentioned constitutions and constitutions of embodiments which will be explained later and various modifications are conceivable without departing from the technical spirit of the present invention.

### BRIEF DESCRIPTION OF THE DRAWINGS

FIG. 1 is a schematic cross-sectional view for explaining an example of the structure of one embodiment of a color cathode ray tube according to the present invention.

FIG. 2 is a graph showing the relationship between the thickness of a boundary portion of an electron beam aperture of a shadow mask and the Irregularity index of a phosphor screen or the like.

FIG. 3 is a view showing the relationship between the surface roughness in the vicinity of the boundary portion of the electron beam aperture of the shadow mask and the Irregularity index of the phosphor screen or the like.

FIG. 4 is a schematic cross-sectional view for explaining an example of the structure of a color cathode ray tube of a black matrix type.

FIG. 5A is a side view of a shadow mask assembled body shown in FIG. 4 and

FIG. 5B is a plan view of the shadow mask assembled body shown in FIG. 4.

FIG. 6 is a schematic cross-sectional view showing a portion of an essential part of the color cathode ray tube shown in FIG. 4 in an enlarged form.

FIG. 7 is a schematic cross-sectional view of one example of an electron beam aperture of a shadow mask.

FIG. 8 is a view showing a geometric-optical exposure profile for explaining the phosphor screen forming exposure.

FIG. 9A is a front view of the panel portion of the color cathode ray tube and

FIG. 9B is an enlarged view of a portion A in FIG. 9A.

FIG. 10A is a view showing a regular geometric-optical exposure profile for explaining the phosphor screen forming exposure and

FIG. 10B ad FIG. 10C are views showing irregular profiles.

FIG. 11 is a schematic cross-sectional view of another example of the electron beam aperture of the shadow mask.

FIG. 12 is a view showing the constitution of one embodiment of an image quality measuring method and device.

### DESCRIPTION OF THE PREFERRED EMBODIMENTS

Preferred embodiments of the present invention are explained hereinafter in detail in conjunction with attached drawings.

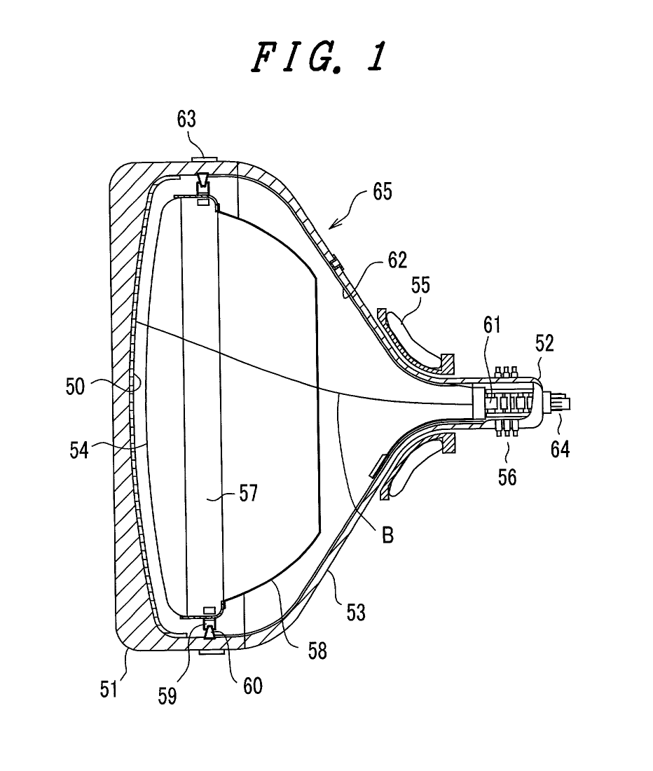

FIG. 1 is a schematic cross-sectional view for explaining an example of the structure of one embodiment of a color cathode ray tube according to the present invention. The color cathode ray tube shown in FIG. 1 includes an evacuated envelope which is constituted of a panel portion 51 having a phosphor screen 50 which has phosphor pixels and a black-matrix film formed of a non-luminance light-absorbing material layer on an inner surface, a neck portion 52 housing an electron gun 61 and a funnel portion 53 which connects the panel portion 51 and the neck portion 52 to each other.

The phosphor screen 50 formed on the inner surface of the panel portion 51 includes phosphor pixels which are formed by applying phosphors of three colors generally consisting of red (R), green (G) and blue (B) in a dot shape or a stripe shape respectively, a black matrix film which surrounds these phosphor pixels and is made of a non-luminance light-absorbing material layer such as carbon and a metal reflection film which constitutes a metal back layer. With respect to the phosphor screen 50, the Irregularity index which expresses the uniformity of phosphor screen which will be explained later is set to a value not greater than 7%. Further, a shadow mask 54 is arranged at a position close to the phosphor screen 50. The shadow mask 54 is constituted of Invar material in view of the thermal expansion coefficient and the physical hardness.

The shadow mask 54 is of a type which can maintain the shape thereof which is formed by press molding by itself. The shadow mask 54 has peripheral sides thereof welded to a mask frame 57 and is supported on stud pins 60 which are mounted on inner walls of skirt portions of the panel portion 51 in an erected manner by way of suspension springs 59 in a suspended manner. Further, a magnetic shield 58 is fixed to an electron gun 61 side of the mask frame 57.

A deflection yoke 55 is exteriorly mounted on a transitional region between the neck portion 52 and the funnel portion 53 of the evacuated envelope. The deflection yoke 55 deflects three modulated electron beams B irradiated from the electron gun 61 in the horizontal direction (X direction) and the vertical (Y direction) so as to perform the two dimensional scanning on the phosphor screen 50 thus reproducing images. Further, an inner conductive film 62 formed on an inner surface of the funnel portion 53 is served for applying high voltage introduced through an anode button to electrodes which constitute a main lens of the electron gun 61 and the metal deflection film of the phosphor screen 50. Here, numeral 65 indicates the whole color cathode ray tube.

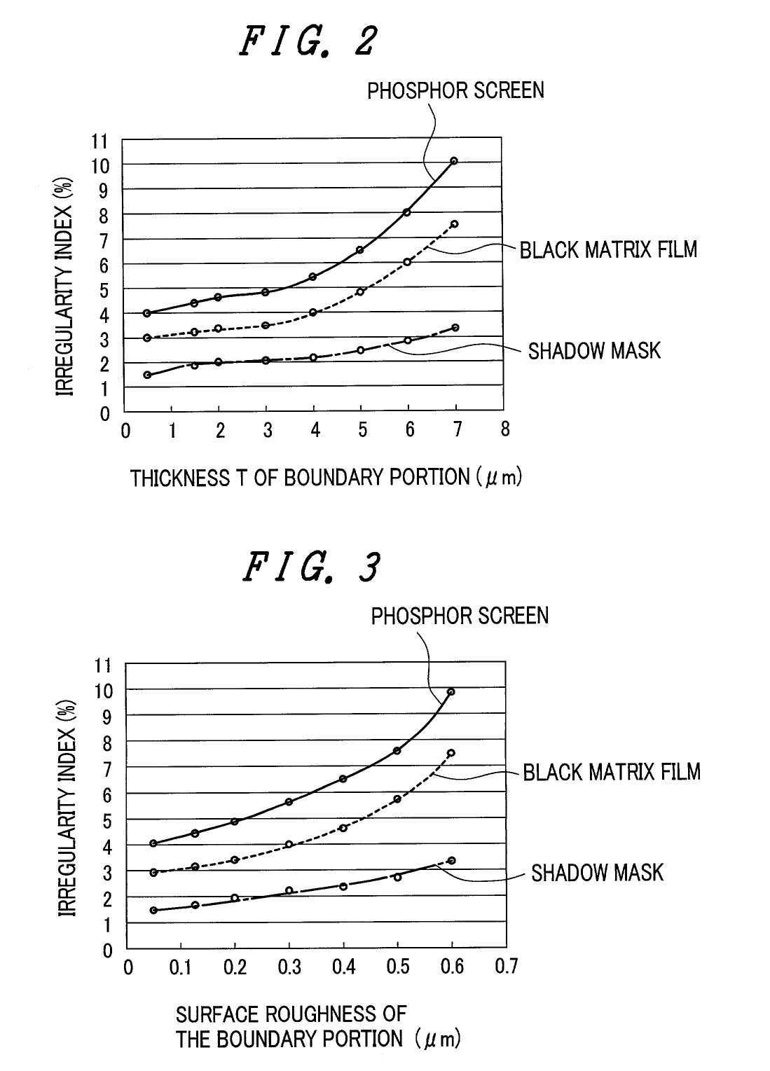

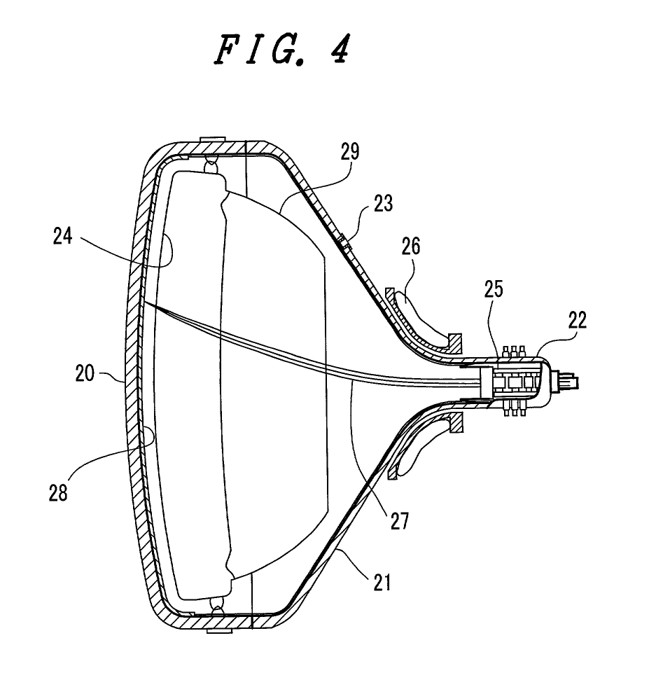

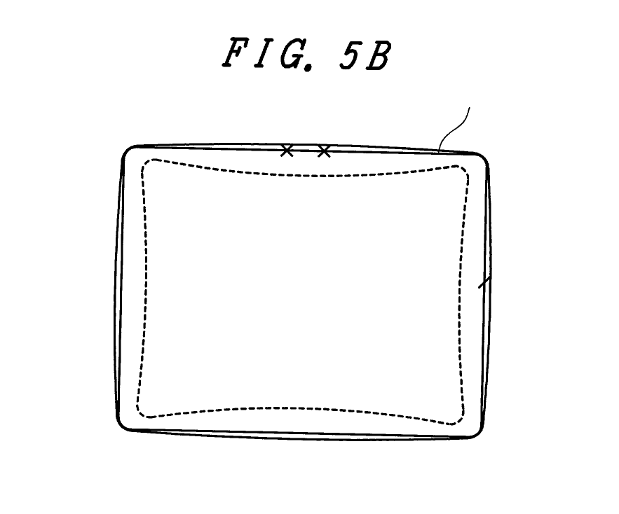

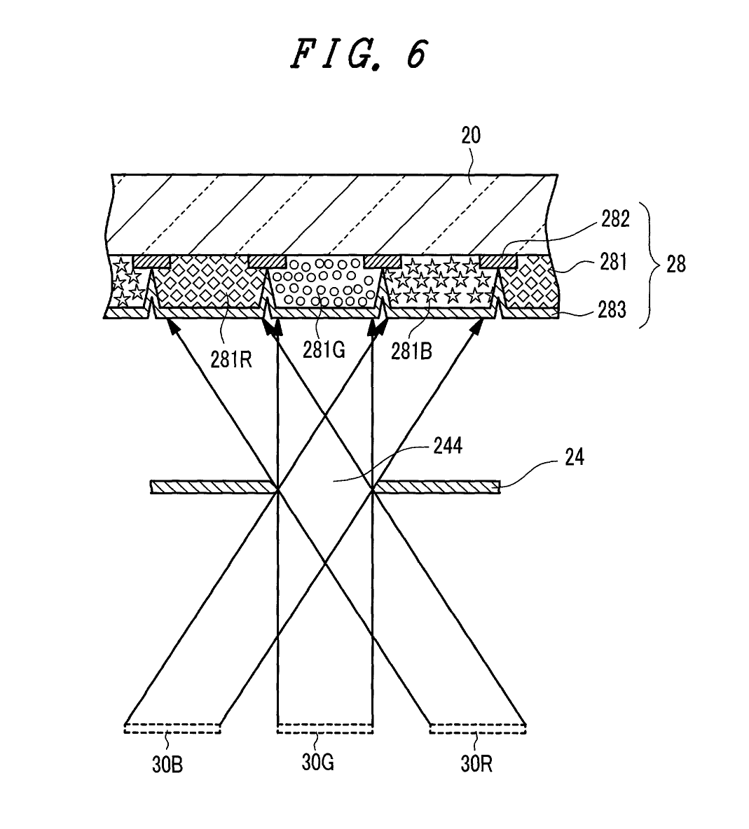

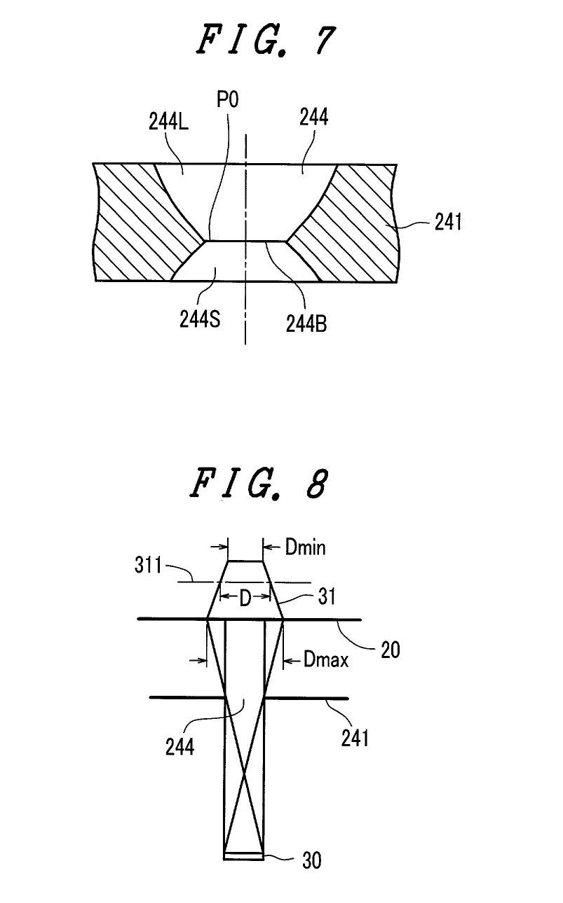

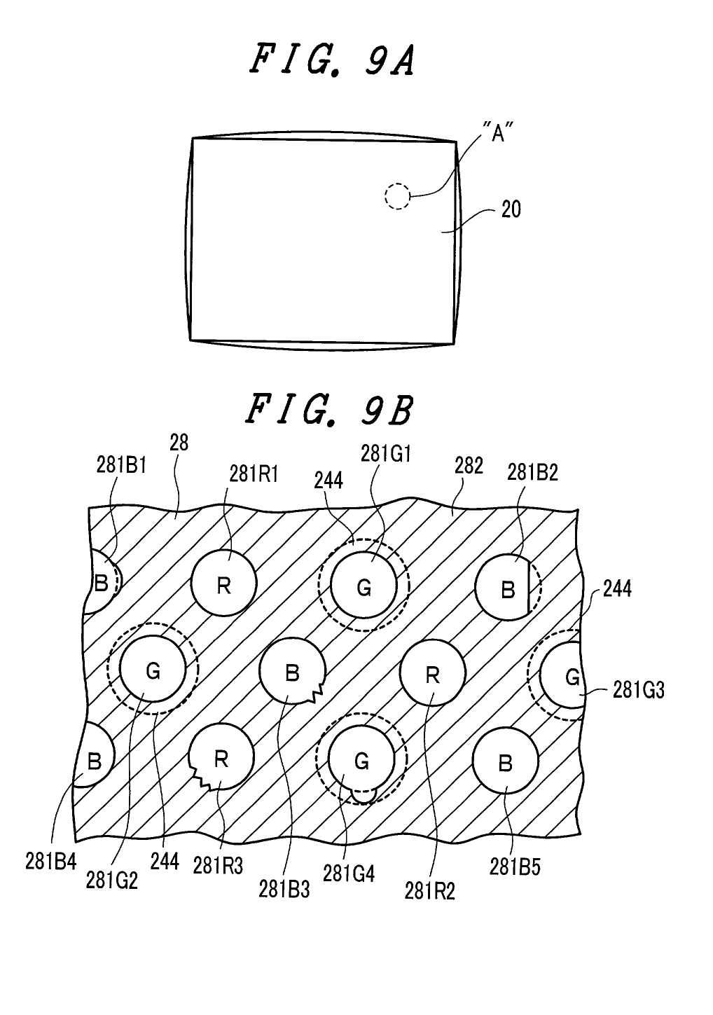

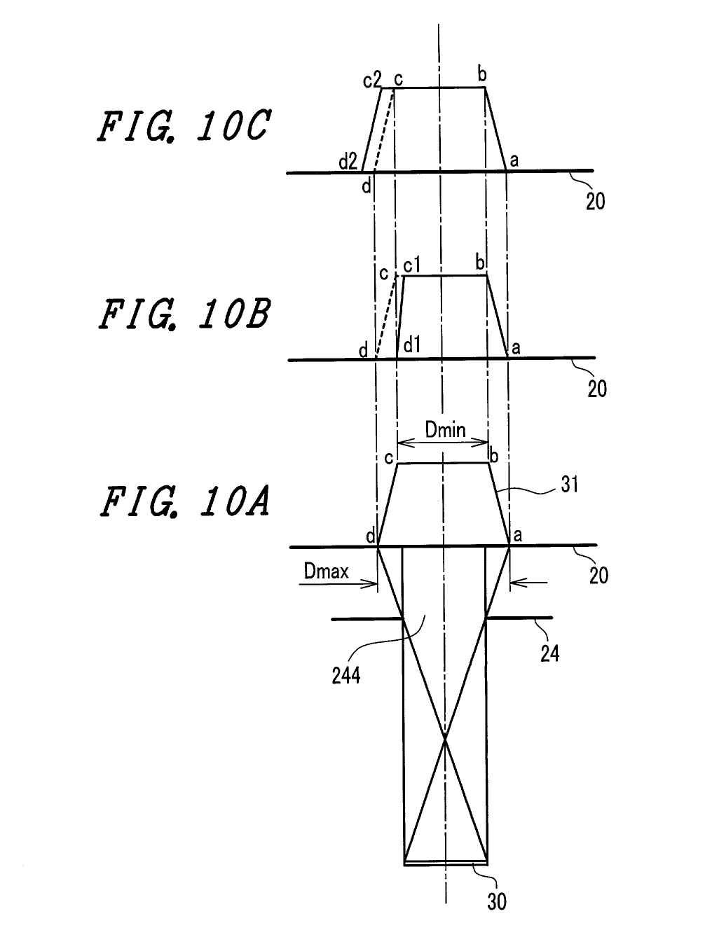

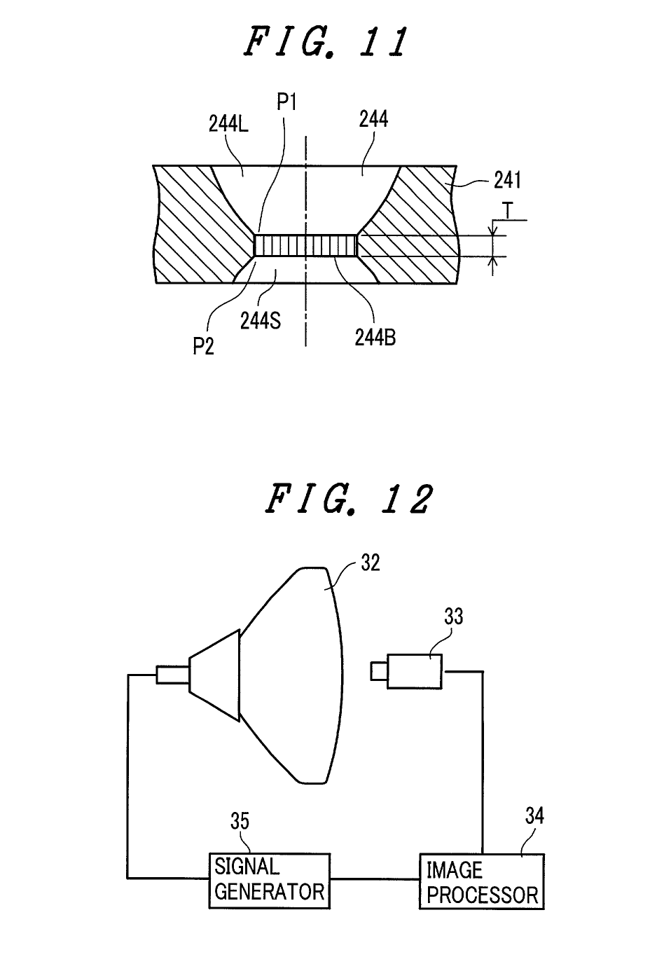

FIG. 2 and FIG. 3 are views showing the relationship between the characteristics of the shadow mask and the Irregularity index which expresses the uniformity of the phosphor screen, the black matrix film and the shadow mask. That is, FIG. 2 shows the relationship between the thickness T of the boundary portion 244b of the electron beam aperture 244 of the shadow mask 241 shown in FIG. 11 and the Irregularity index, while FIG. 3 shows the relationship between the surface roughness in the vicinity of the boundary portion 244b and the Irregularity index. Here, the irregularities of the hole diameter of the electron beam passage apertures 244 formed in the shadow mask used in both of FIG. 2 and FIG. 3 are set within 2%.

First of all, FIG. 2 shows the characteristics of the color cathode ray tube having the specification in which the arrangement distance pitch of the neighboring phosphor pixels of same color is set to 0.26 mm, the shadow mask material is formed of Invar material, the plate thickness of the shadow mask is set to 0.13 mm and the hole diameter of the electron beam passage apertures is set to 115 to 120 μm and the size of the screen in the diagonal direction is 51 cm. The Irregularity index shown in FIG. 2 is a value which is calculated using the technique disclosed in the previously mentioned Japanese Laid-open Patent Publication 253497/1998. As the physical characteristic quantity in the publication, the light emission quantity of the phosphor dot per unit area is used with respect to the screen (phosphor screen) of the monitor tube and the area of the electron beam aperture of the shadow mask or the area of the black matrix hole is used with respect to other cases.

In FIG. 2, when the thickness T of the boundary portion 244b exceeds 6 μm, that is, when the Irregularity index which expressed the uniformity of the phosphor screen exceeds 8%, the gritty irregularities of contrast of the phosphor screen becomes apparent so that the uniformity of the screen is deteriorated and the quality of the screen is damaged whereby the image display of high quality is not obtained. Accordingly, it is necessary to set the Irregularity index which expresses the uniformity of the phosphor screen to a value not greater than 7%. It is desirable to set the irregular index to a value not greater than 5.5%. In this case, the quality of the image display can be further enhanced. When the Irregularity index is not greater than 4%, the presence of the irregularity per se can be ignored. To this end, it is preferable to set the thickness T of the boundary portion 244B to a value not greater than 5 μm.

Subsequently, FIG. 3 shows the result of the evaluation which is confirmed using shadow masks having the different surface roughness of the electron beam passage apertures under the same specification as FIG. 2. When the surface roughness of the electron beam aperture exceeds 0.5 μm, that is, when the Irregularity index which expresses the uniformity of the phosphor screen exceeds 8%, the gritty irregularities of contrast on the phosphor screen becomes apparent so that the uniformity of the screen is deteriorated and the quality of the screen is damaged whereby the image display of high quality can not be obtained.

Accordingly, by setting the surface roughness to a value not greater than 0.4 μm, the image display of high quality can be obtained. Here, data on the hole area of the BM (black matrix) film and the data on the electron beam aperture area of the mask (shadow mask) in FIGS. 2 and 3 are respectively collected during the manufacturing steps of the color cathode ray tube.

Further, although the surface of the shadow mask is usually blackened, by increasing the thickness of the blackened film by at least 10% compared to the blackened film of a standard specification, the Irregularity index can be improved compared to that of the standard specification even when the surface roughness is equal. That is, with respect to the shadow masks having the surface roughness of 0.12 μm and 0.30 μm, the irregularity indices of black matrix films using the blackened films of the standard specification are respectively 3.2% and 4.0%. By increasing the thickness of the blackened films by 10%, the irregularity indices of the black matrix films are respectively improved by 3.1%, 3.6%. Corresponding to such an improvement, the Irregularity index of the phosphor screen is also improved.

Although the relationship between the characteristics of the shadow mask and the Irregularity index has been explained in the above-mentioned embodiments, as causes or factors which generate the irregularities on the phosphor screen, as mentioned previously, besides the material and the process of the shadow mask, the material and the process of the panel, the black matrix film, the phosphor pixels, the metal reflection films or the like are considered. Accordingly, by improving the characteristics and manufacturing controls of these respective components, the Irregularity index can be enhanced.

As has been described heretofore, according to the present invention, by controlling the Irregularity index by synthetically analyzing the irregularities generated on the phosphor screen and searching into causes thereof, the generation of the irregularities can be suppressed, the uniformity of the screen can be enhanced whereby the color cathode ray tube of a black matrix type which can obtain the image display of high quality with the favorable screen quality can be realized.

What we claim is:

1. A color cathode ray tube comprising:
an evacuated envelope which is constituted of a panel having a phosphor screen which forms a large number of sets of three-color phosphor pixel trios on an inner surface thereof, a neck housing an electron gun which irradiates three electron beams toward the phosphor screen in the inside thereof, and a funnel which connects the panel and the neck to each other, and
a shadow mask which arranges an apertured region thereof which performs the color selection of landing positions of the three electron beams and in which a large number of electron beam passage apertures are formed close to the phosphor screen and makes the apertured region face the phosphor screen in an opposed manner, wherein
each electron beam aperture formed in the shadow mask is constituted of a first hole portion opened at the panel side, a second hole portion opened at the electron gun side and a third hole portion which connects the first hole portion and the second hole portion to each other,
with respect to a cross-sectional profile shape of the electron beam aperture which is obtained by cutting along a plane which includes the center of the electron beam aperture and a tube axis, a boundary between the first hole portion and the third hole portion is defined as a first inflection point which reaches the third hole portion from the first hole portion and a boundary between the second hole portion and the third hole portion is defined as a second inflection point which reaches the third hole portion from the second hole portion, and
the distance between the first inflection point and the second inflection point is set to a value not greater than 5 μm.

2. A color cathode ray tube according to claim 1, wherein material which constitutes the shadow mask is Invar.

3. A color cathode ray tube according to claim 1, wherein the surface roughness in the vicinity of the third hole portion is set to a value not greater than 0.4 μm.

4. A color cathode ray tube according to claim 1, wherein the Irregularity index which expresses the uniformity of the phosphor screen is not greater than 7%.

5. A color cathode ray tube according to claim 4, wherein the Irregularity index is not greater than 5.5%.

6. A color cathode ray tube according to claim 4, wherein the phosphor pixels are formed in a dot shape.

7. A color cathode ray tube according to claim 4, wherein each electron beam aperture is formed in the shadow mask such that a large hole is formed at the phosphor screen side and a small hole is formed at the electron gun side with respect to a boundary portion, and the thickness of the boundary portion is set to a value not greater than 5 μm.

8. A color cathode ray tube according to claim 4, wherein with respect to the shadow mask, the surface roughness of the inner surface of the electron beam aperture is set to a value not greater than 0.4 μm.

9. A color cathode ray tube according to claim 4, wherein the Irregularity index which expresses the uniformity of the black matrix film is set to a value not greater than 5%.

10. A color cathode ray tube according to claim 4, wherein the Irregularity index which expresses the uniformity of the shadow mask is set to a value not greater than 3%.
